(19) United States
(12) Patent Application Publication
(10) Pub. No.: US 2009/0153434 A1
(43) Pub. Date: Jun. 18, 2009

(54) Display assistant system

(76) Inventors: Jzung-I Cheng, Hsinchu Industrial Park (TW); Fu-Pao Shih, Hsinchu Industrial Park (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,184

(22) Filed: Mar. 3, 2008

(30) Foreign Application Priority Data
Dec. 14, 2007 (TW) 096148061

(51) Int. Cl. G09G 5/00

(52) U.S. Cl. 345/1.1

(57) ABSTRACT

A display assistant system includes an image capturing and processing unit for re-encoding main display images, secondary display images or screen capture from running process or a portable computer to images data and capturing the re-encoded images data, an image transmission unit for transferring the re-encoded images data and screen capture from running process, an image display unit for decompressing and displaying the images data and screen capture from running process transferred by the image transmission unit, and an LCD display unit. The image capturing and processing unit has display application programs for adjusting and re-encoding pictures and color domains of main display images to images data. The display assistant system dynamically displays images and screen capture from running process or a portable computer on another LCD display.

### BACKGROUND OF THE INVENTION

1. Field of the Invention

The present invention relates to a display assistant system and, particularly, to a display assistant system for displaying images and screen capture from running process of desktop or portable computers on other LCD displays, such as electronic digital frame, mobile phone, PDA, GPS, etc.

2. Related Art

Digital technology is evolving rapidly, and digital products, for example, electronic digital frame, mobile phone, PDA, GPS, etc. are popularly used. The electronic digital frame is outstanding for its multiple functions besides functions of a traditional picture frame. Currently, electronic digital frames are usually utilized in digital personal offices. It is well known that, the electronic digital frame displays images captured by digital cameras through transmission of Universal Serial Bus (USB) or memory cards. Combination of electronic digital frame, digital camera and USB may be called a symbol of utility and digitization.

Innovations have been made by involving desktop or portable computers to such a combination which includes characteristics of a digital product and USB.

### SUMMARY OF THE INVENTION

An object of the present invention is to provide a display assistant system, which dynamically displays images and screen capture from running process or portable computer on other LCD displays, such as electronic digital frame, mobile phone, PDA, GPS, etc., and which can be operated by a single computer and be displayed in multiple display devices.

To achieve the above objects, the display assistant system according to the present invention comprises an image capturing and processing unit for re-encoding main display images, secondary display images or screen capture from running process or a portable computer to images data and capturing the re-encoded images data, an image transmission unit for transferring the re-encoded images data and the screen capture from running process, an image display unit for decompressing and displaying the images data and the screen capture from running process transferred by the image transmission unit, and an LCD display unit. The image capturing and processing unit comprises display application programs for adjusting and re-encoding pictures and color domains of main display images to images data. The application programs include a main display image interface, simulated secondary display driver programs for capturing secondary display images, and capturing, compressing and transmitting images tool programs for capturing the images data, the secondary display images or screen capture from running process and compressing with different compression ratio. The image display unit includes an image decoding and display module and an image receiving module which are compliable with the capturing, compressing and transmitting image tool programs. The LCD display unit connects with the image decoding and display unit, and includes at least an LCD display for displaying the processed images data.

The image transmission unit transfers the re-encoded images data and the screen capture from running process and processing unit to the image display unit by cable transmission of USB, IEEE 1394 or Ethernet, or by wireless transmission of BlueTooth, WiFi, UWB or WiMAX.

### BRIEF DESCRIPTION OF THE DRAWINGS

FIG. 1 is a flow diagram of a display assistant system according to a first embodiment of the present invention.

FIGS. 2A-2D schematically illustrate simulating images data transferred from a main display to an LCD display according to a first embodiment of the present invention.

FIG. 3 is a flow diagram of a display assistant system according to a second embodiment of the present invention.

FIGS. 4A-4D show a desktop computer transferring images data in a main display to an LCD display of an electronic digital frame.

### DESCRIPTION OF THE PREFERRED EMBODIMENTS

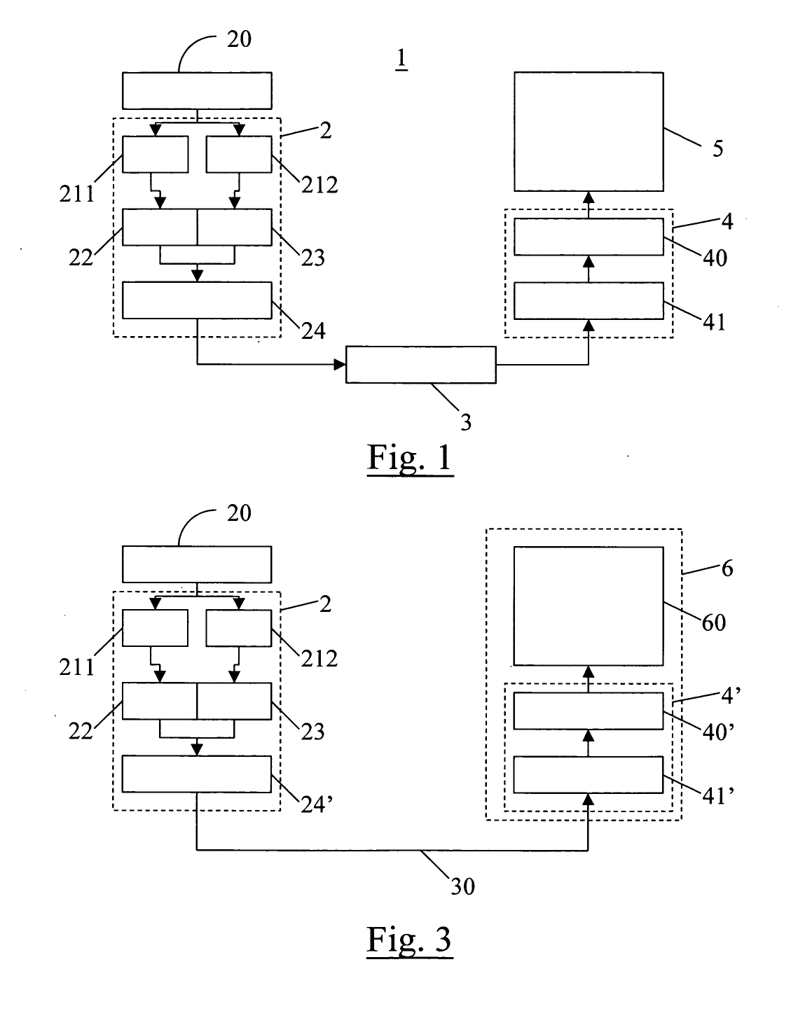

Referring to FIG. 1, a display assistant system 1 in accordance with a first embodiment of the present invention comprises an image capturing and processing unit 2 for re-encoding main display images or secondary display images or screen capture from running process or a portable computer to images data and capturing the re-encoded images, an image transmission unit 3, an image display unit 4 and an LCD display unit 5. The image capturing and processing unit 2 comprises application programs executed in a desktop or a portable computer, which include a main display image interface 22 for capturing main display images 211, simulated secondary display driver programs 23 for capturing secondary display images 212, and capturing, compressing and transferring images tool programs 24 executed in the desktop or portable computer. The simulated secondary display driver programs 23 are, for instance, the driver programs of simulated images produced by Canada Innobec Corporation. The tool programs 24 have functions of scaling and re-setting pictures and color domains. The tool programs 24 are able to adjust and re-encode pictures and color domains to images data (which will be described below), and are able to capture process window. The tool programs 24 capture the image data and the screen capture from running process, and compress with different compression ratio. For instance, the capturing, compressing and transferring images tool programs 24 process images under Windows XP and Windows Vista with different compression ratio. The tool programs 24 may vary corresponding to the transmission way of the image transmission unit 3.

The image transmission unit 3 transfers the re-encoded images data and the screen capture from running process and processing unit 2 into the image display unit 4 by cable transmission, for example USB, IEEE 1394 or Ethernet, or by wireless transmission, for example Blue Tooth, WiFi, UWB or WiMAX. Transmission wires, which comply with USB specification, are respectively provided at both ends of the image transmission unit 3 for transferring the compressed images data.

The image display unit 4 decompresses the images data and the screen capture from running process transferred by the image transmission unit 3, and displays the images data. The image display unit 4 comprises an image decoding and displaying module 40 and an image receiving module 41. The image decoding and displaying module 40 and the image receiving module 41 are compliable with the tool programs 24, and are designed according to the transmission way of the image transmission unit 3. The tool programs 24 are a compression device with a USB transmission platform, and the image receiving module 41 is a decompression device with a USB transmission platform.

The LCD display unit 5 connects with the image display unit 4, and includes at least an LCD display (not shown) for displaying the processed images data.

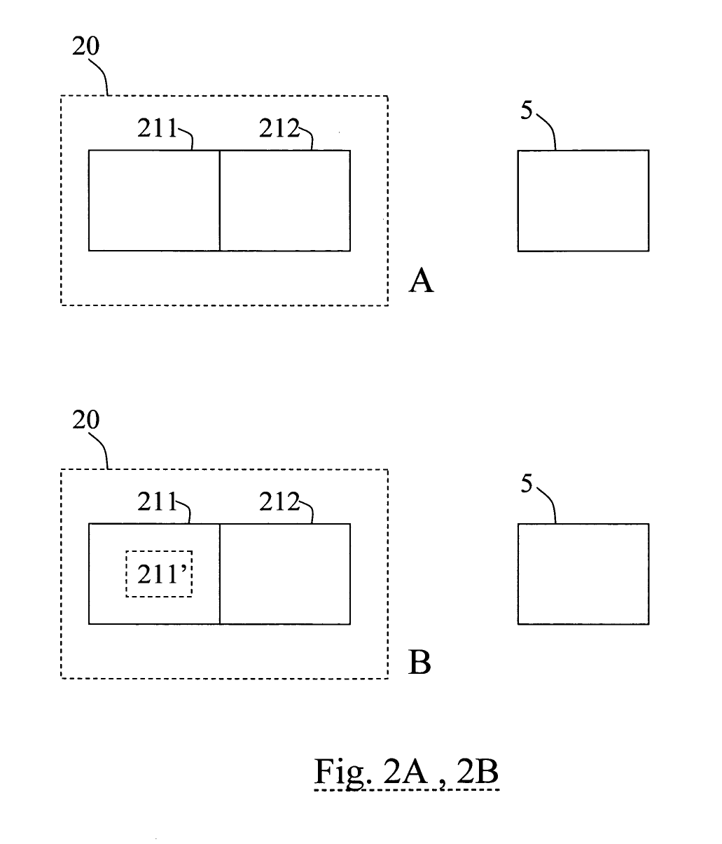

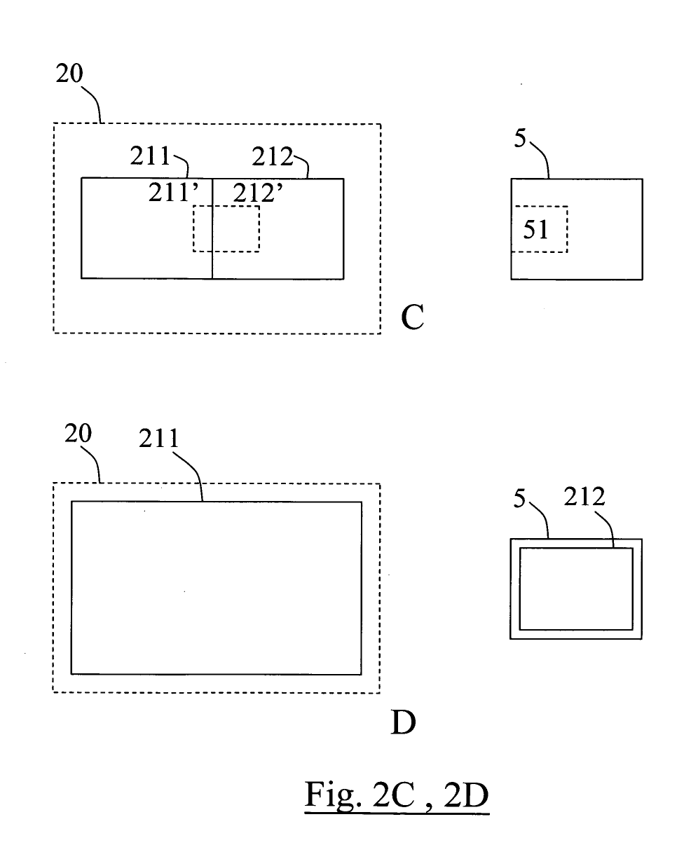

As shown in FIG. 2A, the left block generally stands for a desktop computer (or a portable computer) 20, which includes images stored in the system memory and a driver programs memory, main display images 211 stored in the system RAM, and secondary display images 212 stored in part of system RAM. The right block stands for an LCD display unit 5. The main display images 211 and secondary display images 212 are processed by the main display image interface 22, the simulated display driver programs 23 and the capturing, compressing and transmission tool programs 24 to become main display images 211′ and secondary display images 212′, and are then transferred by the image transmission unit 3. The LCD display unit 5 retrieves the main display images 211′ and secondary display images 212′. The window of the main display images 211′ is a window shown in the main display images 211. The window of the main display images 211′ is dragged to the secondary display image 212 (as shown in FIG. 2C) through a mouse (not shown) of the desktop (portable) computer, generating a window of secondary display images 212′. The window of the main display images 211′ is moved to the secondary display images 212, forming a window of secondary display images 212′. Meantime, the LCD display unit 5 retrieves windows and images 51 as same as what are shown in the window of secondary display images 212′. Thus, the desktop (portable) computer 20 and the LCD display unit 5 can show the main display images 211 and the secondary display images 212 (referring to FIG. 2D), respectively. The present invention provides an operation platform for showing images of a single computer in multiple displays.

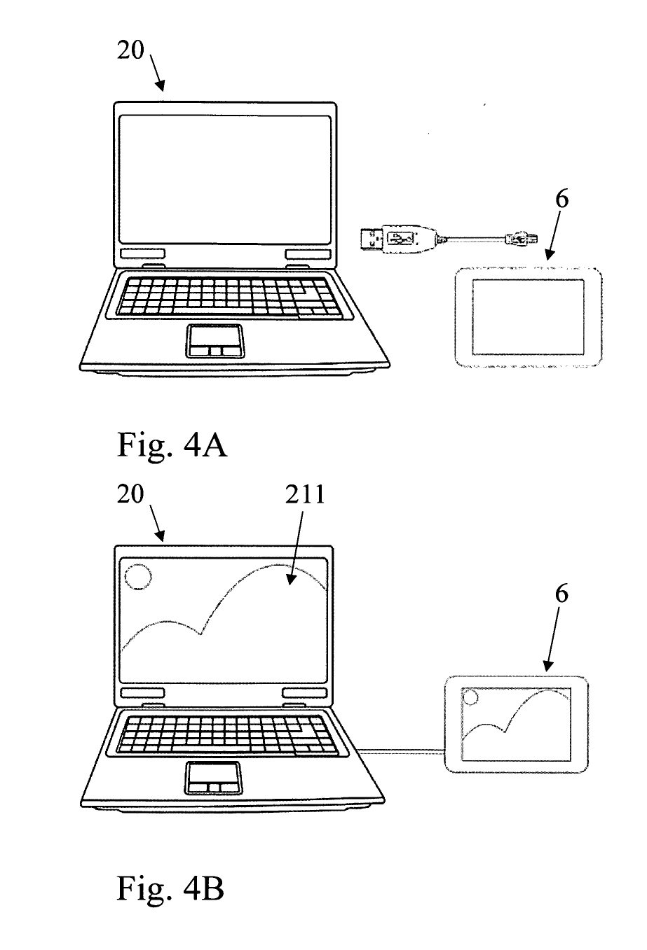

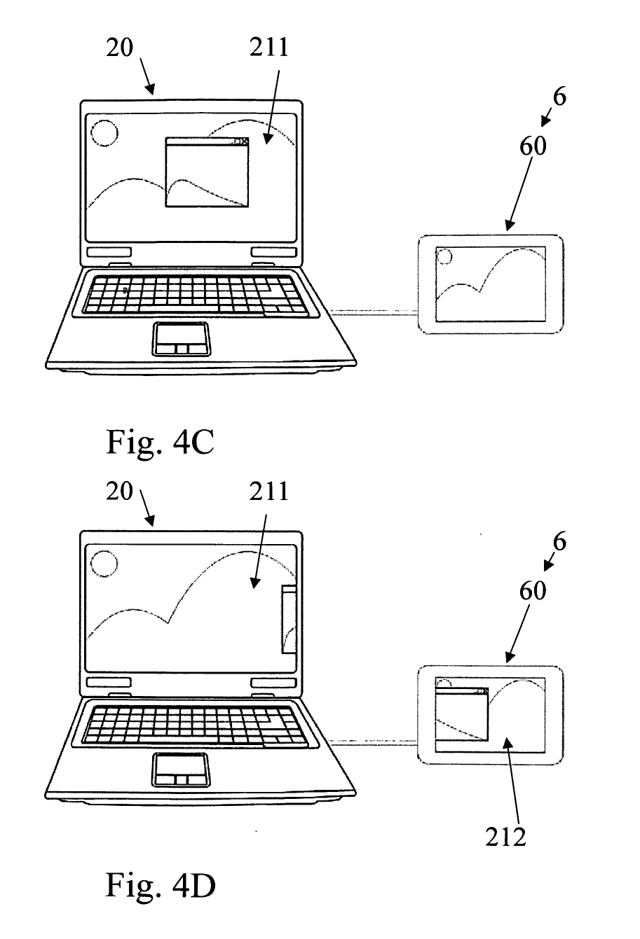

FIG. 3 is a flow diagram of a display assistant system according to a second embodiment of the present invention. The second embodiment is similar to the first embodiment except that an LCD display of an electronic product 6 is used to show the transferred images. The electronic product 6 may be PDA, LCD television, etc. In the second embodiment, an electronic digital frame has an LCD display 60 with an image display unit 4′ built therein. Similarly, in the second embodiment, images and screen capture of the desktop (portable) computer 20 are dynamically shown in the LCD display 60 of the electronic product 6 through the image capturing and processing unit 2, the image transmission unit 3 (by a USB transmission wire 30) and the image display unit 4′, therefore allowing to be displayed in multiple displays and to be operated in a single computer. It is noted that, the image transmission unit 3 adopts USB transmission, and thus, the capturing, compressing and transmission tool programs 24′ has a USB interface. The image display unit 4′ is programmed according to USB protocols, which includes an image display unit 40′ and an image receiving unit 41′ of a USB interface. The main display image 211 and the secondary display unit 212 might be captured and compressed with different compression ratio. Further referring to FIGS. 4A-4D, the electronic digital frame 6 is operated as the steps (FIG. 3) of the present invention, and the windows thereof are dragged as FIGS. 2A-2D. The main display images 211 and the secondary display images 212 of a portable computer 20 are dynamically transferred to the LCD display 60 of the electronic digital frame 6. It can be operated in a single computer and at the time, can be displayed in multiple displays.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A display assistant system, adapted for dynamically displaying images and screen capture from running process of a computer on another LCD display, comprising:
an image capturing and processing unit for re-encoding main display images, secondary display images and screen capture from running process of the desktop or portable computer to images data and capturing the re-encoded images data, comprising display application programs for adjusting and re-encoding pictures and color domains of main display images to images data, the application programs including a main display image interface, simulated secondary display driver programs for capturing secondary display images, and capturing, compressing and transmitting images tool programs for capturing the images data, the secondary display images and screen capture from running process and compressing with different compression ratio,
an image transmission unit for transferring the re-encoded images data and the screen capture from running process;
an image display unit for decompressing and displaying the images data and screen capture from running process transferred by the image transmission unit, the image display unit including an image decoding and display module and an image receiving module which are compliable with the capturing, compressing and transmitting image tool programs; and
an LCD display unit for connecting with the image decoding and display unit, and including at least an LCD display for displaying the processed images data.

2. The display assistant system as recited in claim 1, wherein the capturing, compressing and transmitting images tool programs are executed under Windows environment, and have functions of scaling and re-setting pictures and color domains.

3. The display assistant system as recited in claim 1, wherein the image transmission unit transfers by cable transmission of USB, IEEE 1394 or Ethernet.

4. The display assistant system as recited in claim 1, wherein the image transmission unit transfers by wireless transmission of BlueTooth, WiFi, UWB or WiMAX.

5. The display assistant system as recited in claim 1, wherein the simulated secondary display driver programs are driver programs of simulated images produced by Canada Innobec Corporation.

6. The display assistant system as recited in claim 5, wherein the capturing, compressing and transferring images tool programs process images under Windows XP and Windows Vista with different compression ratio.

7. The display assistant system as recited in claim 1, wherein the capturing, compressing and transferring images tool programs are a compression device with a USB transmission platform, and the image receiving module is a decompression device with a USB transmission platform.

8. The display assistant system as recited in claim 7, wherein transmission wires complying with USB specification are respectively provided at both ends of the image transmission unit for transferring the compressed images data.

9. A display assistant system, adapted for dynamically displaying main display images, secondary display images and screen capture from running process on an electronic product of LCD display, comprising:
an image capturing and processing unit for re-encoding main display images, secondary display images and screen capture from running process of the desktop or portable computer to images data and capturing the re-encoded images data, comprising display application programs for adjusting and re-encoding pictures and color domains of main display images to images data, the application programs including an main display image interface, simulated secondary display driver programs for capturing secondary display images, and capturing, compressing and transmitting images tool programs for capturing the images data, the secondary display images and screen capture from running process and compressing with different compression ratio;
an image transmission unit for transferring the re-encoded images data and screen capture from running process;
an electronic product with an LCD display, an image display unit being built in the LCD display for decompressing and displaying the images data, the secondary display images and screen capture from running process transferred by the image transmission unit, the image display unit including an image receiving module and an image decoding and display module.

10. The display assistant system as recited in claim 9, wherein the capturing, compressing and transmitting images tool programs are executed in a desktop or portable computer, and have functions of scaling and re-setting pictures and color domains.

11. The display assistant system as recited in claim 10, wherein the simulated secondary display driver programs are driver programs of simulated images produced by Canada Innobec Corporation.

12. The display assistant system as recited in claim 11, wherein wherein the capturing, compressing and transferring images tool programs process images under Windows XP and Windows Vista with different compression ratio.

13. The display assistant system as recited in claim 12, wherein the electronic product is an electronic digital frame.

14. The display assistant system as recited in claim 13, wherein the capturing, compressing and transferring images tool programs are a compression device with a USB transmission platform, and the image receiving module is a decompression device with a USB transmission platform.

15. The display assistant system as recited in claim 14, where in transmission wires complying with USB specification are respectively provided at both ends of the image transmission unit for transferring the compressed images data.
